(19) United States
(12) Patent Application Publication
(10) Pub. No.: US 2011/0154395 A1
(43) Pub. Date: Jun. 23, 2011

(54) METHOD AND APPARATUS FOR PROVIDING IPTV RECEPTION INFORMATION OVER HFC NETWORK

(75) Inventor: Woongshik YOU, Gyeryong Si (KR)

(73) Assignee: Electronics and Telecommunications Research Institute, Daejeon (KR)

(21) Appl. No.: 12/889,038

(22) Filed: Sep. 23, 2010

(30) Foreign Application Priority Data
Dec. 23, 2009 (KR) 10-2009-0129819

(51) Int. Cl. H04N 7/173; H04N 5/445

(52) U.S. Cl. 725/39; 725/110

(57) ABSTRACT

An apparatus of providing Internet Protocol Television (IPTV) reception information includes a Cable Modem (CM) to provide an interactive service that enables an IPTV broadcast content including service information, and a Data Over Cable Service Interface Specification (DOCSIS) Media Access Control Management Message (MMM) based on the service information to be received from a cable network, or enables an IPTV broadcast content control signal to be transmitted from a subscriber to the cable network, and a Set-Top Box (STB) to decode the IPTV broadcast content received from the CM and to transmit the decoded IPTV broadcast content to a display device. The STB may receive an IPTV broadcast content selected by a user using Layer 2 (L2) reception information bounded to the IPTV broadcast content. Thus, it is possible to receive an IPTV broadcast content selected by a user directly without a delay time.

### CROSS-REFERENCE TO RELATED APPLICATION

This application claims the benefit of Korean Patent Application No. 10-2009-0129819, filed on Dec. 23, 2009, in the Korean Intellectual Property Office, the disclosure of which is incorporated herein by reference.

### BACKGROUND

1. Field of the Invention

The present invention relates to a method of providing Internet Protocol Television (IPTV) reception information to provide an IPTV service using a cable network, and an apparatus using the method.

2. Description of the Related Art

A broadcast service and a communication service are currently provided through different channels over a cable network.

A Video on Demand (VoD) service using Internet Protocol (IP) packets is partially provided through a communication channel on a cable network. However, the VoD service is similar to a point-to-point communication service where a VoD content selected by an individual viewer is provided in the form of a download, rather than a real-time broadcast that multiple viewers simultaneously view being provided.

A real-time IP television (IPTV) service enables a plurality of viewers to simultaneously access and view a single content, however, has various technical problems to be solved, for example a zapping time caused by a channel switching.

A currently provided IPTV service enables a content selected by a viewer to be transmitted to a subscriber terminal, and is different from a current broadcast service where all channels currently being broadcast are provided to a subscriber terminal, such as a Set-Top Box (STB), regardless of whether viewing a specific channel. In the IPTV service, a considerable delay may occur while channel switching, which is one of the various technical problems to be solved.

Broadcast viewers generally feel bored when a delay time exceeds about 2.5 seconds during channel switching. It has been known that an analog broadcast incurs a channel switching time of less than 1 second, a digital cable broadcast incurs a channel switching time of 1.2 to 2 seconds, a digital satellite broadcast incurs a channel switching time of about 1.8 second, and a Digital Multimedia Broadcasting (DMB) incurs a channel switching time of 3 to 5 seconds.

Currently, in an IPTV, an Electronic Program Guide (EPG) is used to transfer information regarding serviced contents to viewers.

Typically, to view content via the IPTV, there is a need to perform a serial signaling procedure of selecting a desired IPTV broadcast content using the EPG, and joining an IPTV multicast group to receive an IPTV content.

During the signaling procedure, a viewer may feel inconvenience before viewing a selected IPTV broadcast content, since a delay is incurred due to channel switching.

### SUMMARY

According to an aspect of the present invention, there is provided a subscriber terminal including a content receiver to receive a selected Internet Protocol Television (IPTV) broadcast content from a cable network using Layer 2 (L2) reception information, the L2 reception information being bounded to the IPTV broadcast content; a decoder to decode the received IPTV broadcast content; and a transmitter to transmit the decoded IPTV broadcast content to a display device.

According to another aspect of the present invention, there is provided a content provider headend including a content receiver to receive an IPTV broadcast content from a content provider; and a provider to provide a subscriber terminal with a Data Over Cable Service Interface Specification (DOCSIS) Media Access Control Management Message (MMM), the DOCSIS MMM including L2 reception information obtained by reflecting service information for the received IPTV broadcast content, wherein the L2 reception information is used by the subscriber terminal to receive the IPTV broadcast content.

According to another aspect of the present invention, there is provided an apparatus of providing IPTV reception information, the apparatus including a content provider headend to receive an IPTV broadcast content from a content provider, and to provide the subscriber terminal with a DOCSIS MMM, the DOCSIS MMM including L2 reception information obtained by reflecting service information for the received IPTV broadcast content; and a subscriber terminal to receive the IPTV broadcast content and the DOCSIS MMM from a cable network, to decode the received IPTV broadcast content, and to transmit the decoded IPTV broadcast content to a display device.

According to another aspect of the present invention, there is provided a method of operating a subscriber terminal, the method including receiving a selected IPTV broadcast content from a cable network using L2 reception information, the L2 reception information being bounded to the IPTV broadcast content; decoding the received IPTV broadcast content; and transmitting the decoded IPTV broadcast content to a display device.

According to another aspect of the present invention, there is provided a method of operating a content provider headend, the method including receiving an IPTV broadcast content from a content provider; and providing a subscriber terminal with a DOCSIS MMM, the DOCSIS MMM including L2 reception information obtained by reflecting service information for the received IPTV broadcast content, wherein the L2 reception information is used by the subscriber terminal to receive the IPTV broadcast content.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a network including an Internet Protocol Television (IPTV) reception information providing apparatus according to an embodiment of the present invention;

FIG. 2 is a flowchart illustrating a scheme of forming, by a headend, IPTV reception information, generating a Data Over Cable Service Interface Specification (DOCSIS) Media Access Control Management Message (MMM) based on the IPTV reception information, and transmitting the generated DOCSIS MMM, according to an embodiment of the present invention;

FIG. 3 is a flowchart illustrating a scheme of periodically receiving, by a terminal, a DOCSIS MMM that is formed based on IPTV reception information by a headend according to an embodiment of the present invention;

FIG. 4 is a flowchart illustrating a scheme of joining a service using IPTV service information (for example, an Electronic Program Guide (EPG)) provided by an application program, and using Layer 2 (L2) reception information contained in a DOCSIS MMM;

FIG. 5 is a flowchart illustrating a scheme of leaving an IPTV service in an IPTV reception information providing method, according to an embodiment of the present invention;

FIG. 6 is a diagram illustrating a format of a DOCSIS MMM according to an embodiment of the present invention; and

FIGS. 7 and 8 are diagrams illustrating a format of an L2 message (namely, a DOCSIS MMM) including IPTV reception information, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

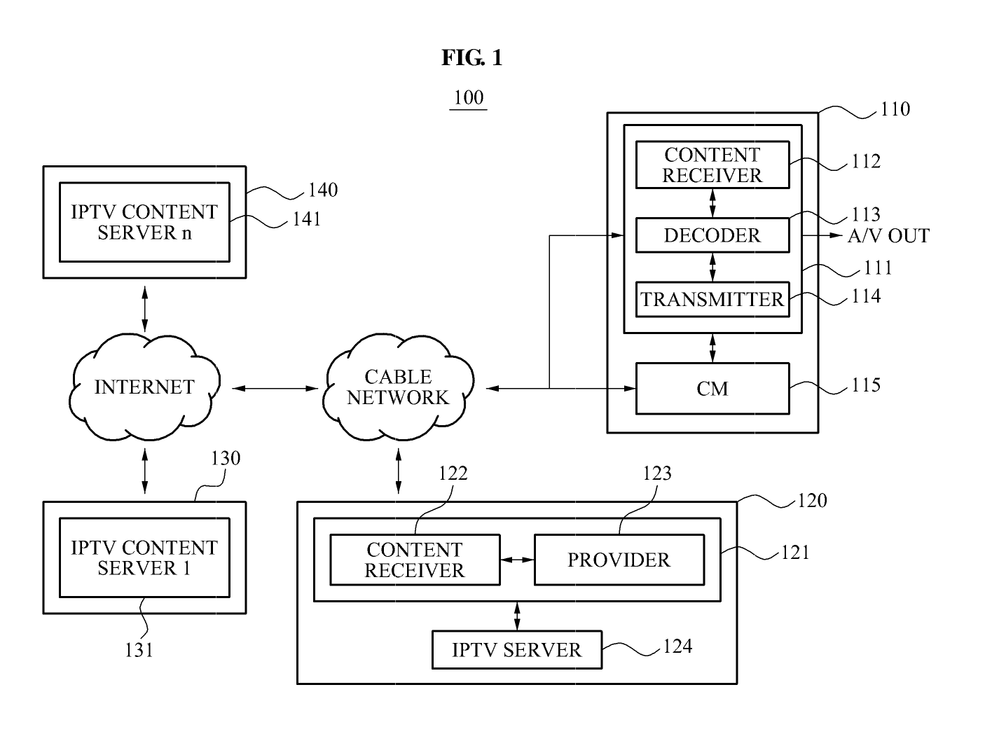

FIG. 1 is a diagram illustrating a network 100 including an Internet Protocol Television (IPTV) reception information providing apparatus according to an embodiment of the present invention.

The IPTV reception information providing apparatus may include a content provider headend 120, and a subscriber terminal 110. The content provider headend 120 may receive an IPTV broadcast content from a content provider, and may provide the subscriber terminal 110 with a Data Over Cable Service Interface Specification (DOCSIS) Media Access Control Management Message (MMM) that includes Layer 2 (L2) reception information obtained by reflecting service information for the received IPTV broadcast content. The subscriber terminal 110 may receive the IPTV broadcast content and the DOCSIS MMM from the content provider headend 120, may decode the received IPTV broadcast content, and may transmit the decoded IPTV broadcast content to a display device. Accordingly, the IPTV reception information providing apparatus may provide a subscriber with IPTV broadcast content as a service. Additionally, the IPTV reception information providing apparatus may reduce a delay time caused by channel switching when providing an IPTV service through the network 100, thereby preventing a viewer from feeling bored.

The IPTV reception information providing apparatus may form a part of the network 100, and may provide the subscriber terminal 110 with an IPTV service, or may display an IPTV broadcast content using the provided IPTV service.

Referring to FIG. 1, the network 100 may include the subscriber terminal 110, the content provider headend 120, an IPTV server 124, IPTV broadcast content provider headends 130 and 140, and IPTV content servers 131 and 141. The subscriber terminal 110 may receive communication and broadcast services through a cable network. The content provider headend 120, and the IPTV server 124 may provide the communication and broadcast services. The IPTV broadcast content provider headends 130 and 140, and the IPTV content servers 131 and 141 may provide IPTV broadcast contents. The elements in the network 100 may be connected to each other through the cable network and an Internet network.

To provide an IPTV service over the cable network, the IPTV reception information providing apparatus may include the subscriber terminal 110 to receive the communication and broadcast services through the cable network, and the content provider headend 120 to provide the communication and broadcast services.

The subscriber terminal 110 may include a Cable Modem (CM) 115, and a Set-Top Box (STB) 111. The CM 115 may provide an interactive communication service, and the STB 111 may decode an IPTV broadcast content and output the decoded IPTV broadcast content.

The STB 111 may include a content receiver 112, a decoder 113, and a transmitter 114. The content receiver 112 may receive an IPTV broadcast content from a cable network using L2 reception information that is bounded to the IPTV broadcast content. The decoder 113 may decode the received IPTV broadcast content, and the transmitter 114 may transmit the decoded IPTV broadcast content to a display device. Additionally, the content receiver 112 may receive information associated with the IPTV broadcast content from the cable network through the CM 115, based on content selection information of an IPTV broadcast content corresponding to the service information.

Specifically, the CM 115 may provide an interactive service that enables an IPTV broadcast content containing the service information to be received from the cable network, or enables an IPTV broadcast content control signal to be transmitted from a subscriber to the cable network.

The STB 111 may decode the IPTV broadcast content received by the CM 115, and may transmit the decoded IPTV broadcast content to the display device. The display device may display the received IPTV broadcast content.

According to an embodiment of the present invention, the STB 111 may receive information associated with the IPTV broadcast content from the cable network through the CM 115, based on content selection information of an IPTV broadcast content corresponding to the service information.

The IPTV reception information providing apparatus may include the content provider headend 120 to provide the subscriber terminal 110 with the communication and broadcast services, as described above.

The content provider headend 120 may include a Cable Modem Termination System (CMTS) 121, and the IPTV server 124.

The CMTS 121 may include a content receiver 122, and a provider 123. The content provider 122 may receive an IPTV broadcast content from a content provider. The provider 123 may provide the subscriber terminal 110 with the DOCSIS MMM that includes L2 reception information obtained by reflecting service information for the received IPTV broadcast content. Here, the CMTS 121 may allow the subscriber terminal 110 to receive the IPTV broadcast content based on the L2 reception information.

The IPTV server 124 may form service information associated with an IPTV broadcast content that is to be provided to the subscriber terminal 110. For example, the service information may include an Electronic Program Guide (EPG).

The CMTS 121 may receive the IPTV broadcast content from the content provider, may add the service information to the received IPTV broadcast content, and may provide the subscriber terminal 110 with the IPTV broadcast content based on the service information.

For example, to provide IPTV broadcast contents over the cable network, the content provider headend 120 including the CMTS 121 and the IPTV server 124 may receive provided contents from the IPTV content servers 131 and 141 that are respectively located in the IPTV broadcast content provider headends 130 and 140.

The IPTV server 124 may form service information associated with IPTV broadcast contents that are to be provided to the subscriber terminal 110.

To form service information for provided contents, various schemes may be provided, for example, a scheme of using an EPG.

IPTV service information including an EPG may be used by a viewer to select content from an application program layer.

In the current embodiment of the present invention, the IPTV server 124 may form service information associated with IPTV broadcast contents, and may transmit reception information in a DOCSIS layer as a separate DOCSIS MMM. Here, the reception information in the DOCSIS layer may be used to receive the service information.

Accordingly, it is possible to view an IPTV immediately by setting the reception information in the DOCSIS layer, namely an L2 Media Access Control (MAC) layer, without joining and leaving a multicast group in an application layer for a currently transmitted IPTV broadcast content.

According to an embodiment of the present invention, it is possible to significantly reduce a delay time caused by channel switching when an IPTV service is provided using a cable network. Additionally, it is possible to define an MMM in a separate DOCSIS layer that includes IPTV reception information based on service information associated with IPTV broadcast contents that are currently provided to a viewer. Furthermore, it is possible to view an IPTV immediately by setting reception information in a DOCSIS layer, namely an L2 MAC layer, without joining and leaving a multicast group in an application layer for IPTV broadcast content.

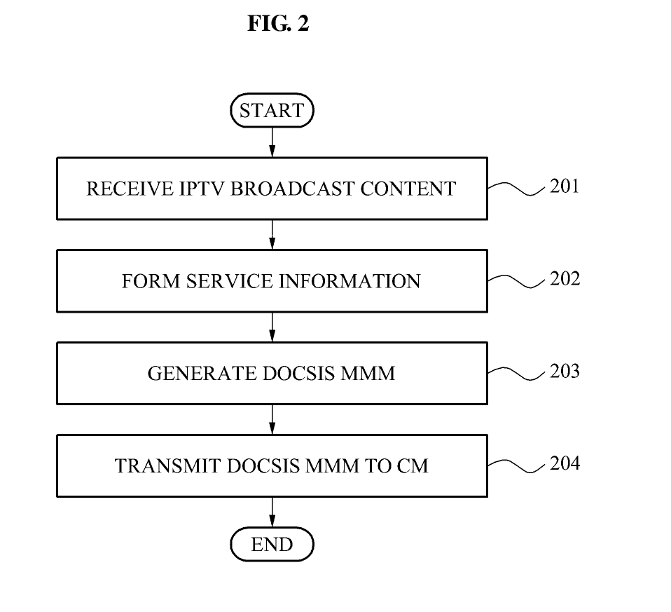

FIG. 2 is a flowchart illustrating a scheme of forming, by a headend, IPTV reception information, generating a DOCSIS MMM based on the IPTV reception information, and transmitting the generated DOCSIS MMM in an IPTV reception information providing method, according to an embodiment of the present invention.

For example, the scheme of FIG. 2 may be interpreted as a scheme of operating a content provider headend according to an embodiment of the present invention.

Referring to FIG. 2, in operation 201, an IPTV broadcast content may be received from a content provider.

In operation 202, service information associated with the received IPTV broadcast content may be formed.

In operation 203, a DOCSIS MMM may be generated based on the formed service information. Specifically, an IPTV server located in the content provider headend may form service information associated with received IPTV broadcast contents.

In operation 204, the generated DOCSIS MMM may be transmitted to a CM.

Here, the CM may receive the DOCSIS MMM, may parse the received DOCSIS MMM, and may periodically update IPTV reception information.

According to an embodiment of the present invention, a CMTS located in a cable headend may periodically transmit a DOCSIS MMM including IPTV reception information to a subscriber terminal via a downstream channel.

In the IPTV reception information providing method, to provide the IPTV reception information to the subscriber terminal, an IPTV broadcast content may be selected based on the service information, and the selected IPTV broadcast content may be transmitted to the CM. Here, the CM may set related reception information based on the IPTV broadcast content.

The CM may receive an IPTV broadcast content based on the set reception information.

The CMTS in the content provider headend may form a DOCSIS MMM including IPTV reception information based on IPTV service information provided by the IPTV server.

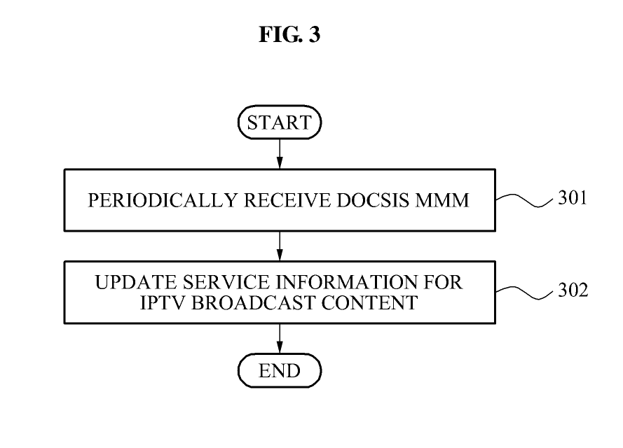

FIG. 3 is a flowchart illustrating a scheme of periodically receiving, by a terminal, a DOCSIS MMM that is formed based on IPTV reception information by a headend in an IPTV reception information providing method according to an embodiment of the present invention. For example, the scheme of FIG. 3 may be interpreted as a scheme of operating a subscriber terminal.

Referring to FIG. 3, in operation 301, a DOCSIS MMM may be periodically received by a CM in a subscriber terminal.

In operation 302, service information for an IPTV broadcast content may be updated based on the received DOCSIS MMM.

As described above, in an IPTV reception information providing method according to an embodiment of the present invention, a CM in a subscriber terminal may periodically receive a DOCSIS MMM including IPTV reception information that is transmitted by a CMTS in a content provider headend. Additionally, the CM in the subscriber terminal may parse the received DOCSIS MMM, and may extract the IPTV reception information from the DOCSIS MMM, to periodically update the extracted IPTV reception information.

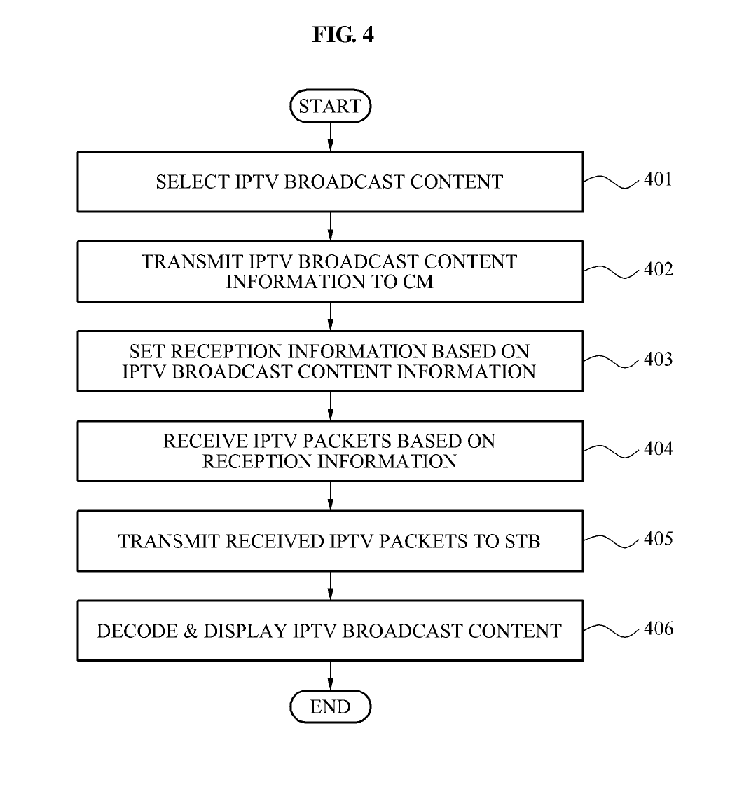

FIG. 4 is a flowchart illustrating a scheme of joining a service using IPTV service information provided by an application program, and using L2 reception information contained in a DOCSIS MMM. Here, the IPTV service information may include, for example, an EPG.

For example, a scheme of joining an IPTV service using IPTV reception information will be described with reference to FIG. 4.

Referring to FIG. 4, in operation 401, an STB in a subscriber terminal may select an IPTV broadcast content based on IPTV service information, such as an EPG, provided by an application layer. In operation 402, the STB may transmit, to a CM in the subscriber terminal, IPTV broadcast content information regarding the selected IPTV broadcast content. Here, the IPTV broadcast content information may include, for example, an identifier (ID) of the selected IPTV broadcast content.

In operation 403, the CM may set reception information related to the IPTV broadcast content based on the IPTV broadcast content information received from the STB. Here, the reception information may include, for example, a Data Set ID (DSID). In operation 404, the CM may filter IPTV packets from the IPTV broadcast content based on the set reception information, and may receive the IPTV packets. In operation 405, the CM may transmit the received IPTV packets to the STB. In operation 406, the STB may decode the IPTV broadcast content including the received IPTV packets, and may display the decoded IPTV broadcast content.

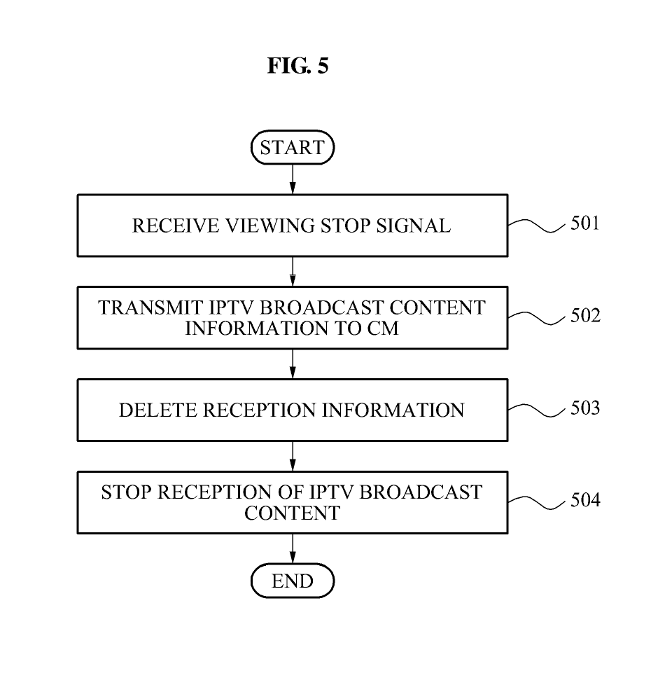

FIG. 5 is a flowchart illustrating a scheme of leaving an IPTV service in an IPTV reception information providing method, according to an embodiment of the present invention.

Referring to FIG. 5, in operation 501, an STB in a subscriber terminal may receive a viewing stop signal to stop viewing of a currently provided IPTV broadcast content when channel switching is requested. In operation 502, the STB may transmit, to a CM in the subscriber terminal, IPTV broadcast content information, such as an ID of the IPTV broadcast content. In operation 503, the CM may delete reception information related to the IPTV broadcast content, based on the IPTV broadcast content information provided by the STB. Here, the reception information may include, for example, a DSID of the IPTV broadcast content. In operation 504, the CM may stop a reception of the IPTV broadcast content. In other words, it is possible to stop the reception of the currently viewed IPTV broadcast content by deleting the reception information using the CM in the subscriber terminal.

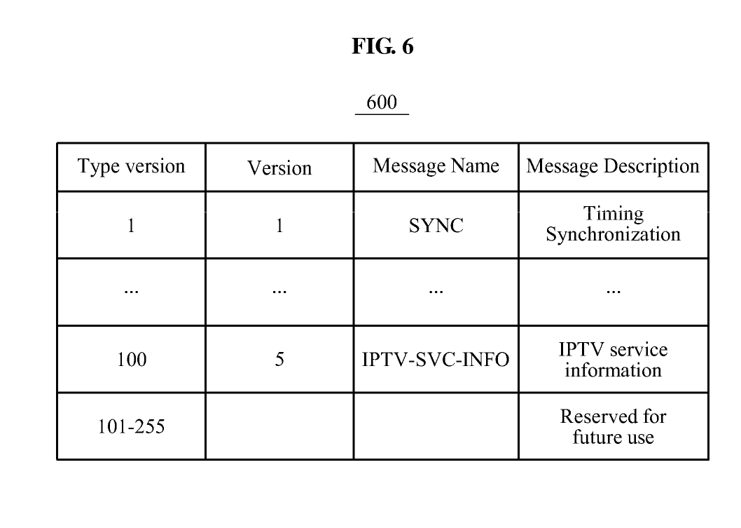

FIG. 6 is a diagram illustrating a format of a DOCSIS MMM 600 according to an embodiment of the present invention.

The DOCSIS MMM 600 may have a same format as a conventional DOCSIS message. For example, fields such as a Frame Control field may be equivalently used in different DOCSIS MMMs, and a new type value may be added to a DOCSIS MMM to include IPTV reception information.

Referring to FIG. 6, a new type value is assigned to the DOCSIS MMM 600. Specifically, a type value of “100” or another value may be assigned to the DOCSIS MMM 600, and the DOCSIS MMM 600 with the type value of “100” may be used as a new IPTV-SVC-INFO message for IPTV reception information. In other words, several DOCSIS MMMs may be distinguished by type information. For example, a DOCSIS MMM having a type value of “100” may be interpreted as an IPTV-SVC-INFO message.

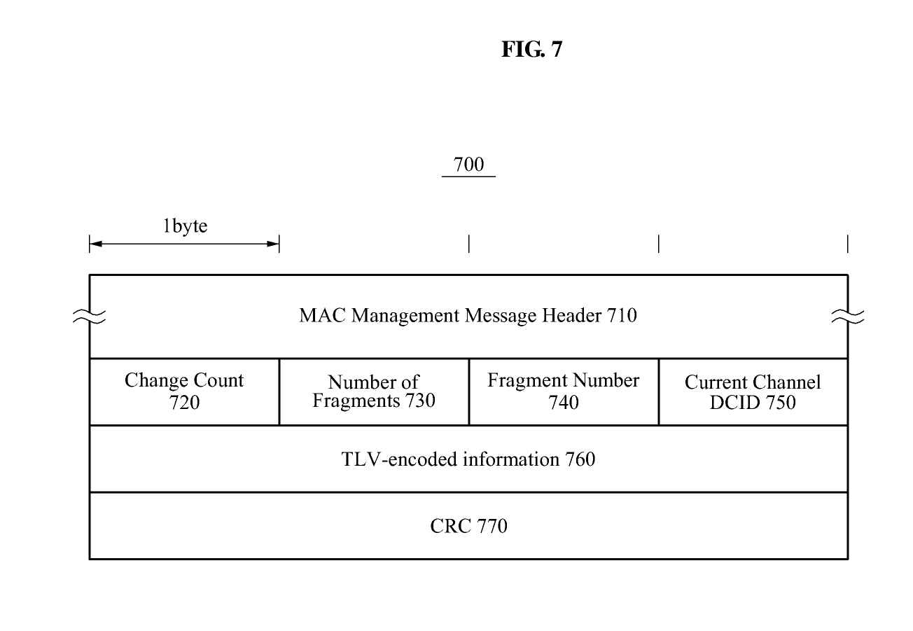

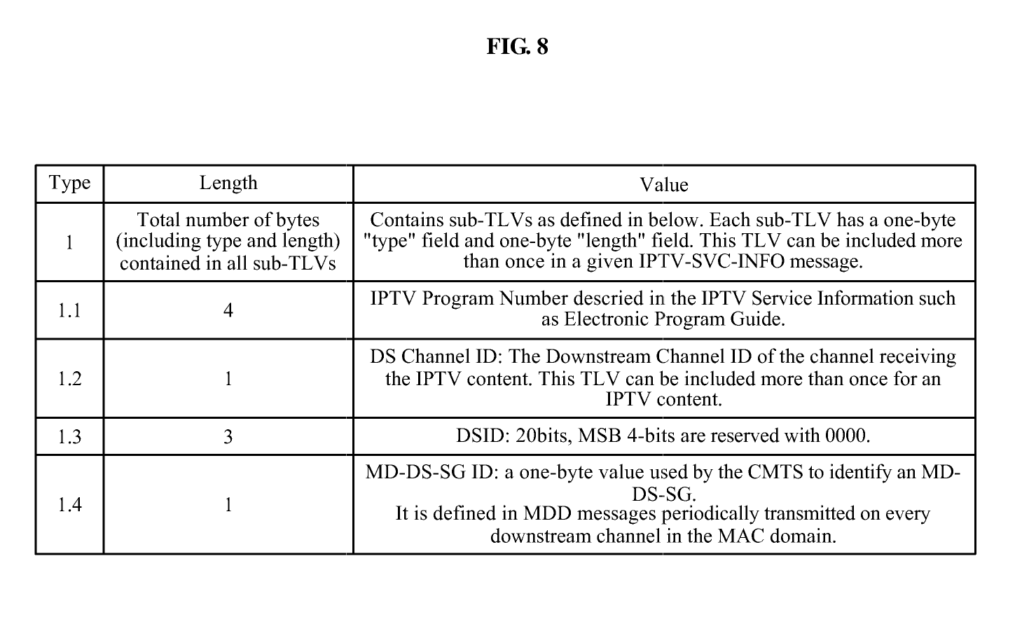

FIGS. 7 and 8 are diagrams illustrating a format of an L2 message (namely, a DOCSIS MMM) including IPTV reception information, according to an embodiment of the present invention.

FIG. 7 illustrates an example of a format of an IPTV-SVC-INFO message 700 as a new DOCSIS MMM including IPTV reception information. The IPTV-SVC-INFO message 700 may be used by assigning a type value of “100” or another value to a DOCSIS MMM.

In FIG. 7, the IPTV-SVC-INFO message 700 may include a header field 710, a Change Count field 720, a Number of Fragments field 730, a Fragment Number field 740, and a Current Channel DCID field 750.

In addition, the IPTV-SVC-INFO message 700 may further include a Type/Length/Value (TLV)-encoded information field 760 to store information regarding TLV-encoding, and a Cyclic Redundancy Check (CRC) field 770.

A value of the Change Count field 720 may be incremented by “1” whenever IPTV reception information is changed. A CM in a subscriber terminal may determine whether the IPTV reception information is changed, based on the value of the Change Count field 720, and may update the IPTV reception information.

The Number of Fragments field 730 may exceed a maximum size of a single DOCSIS MAC Frame, when a large amount of all IPTV reception information is provided. Accordingly, the DOCSIS MAC Frame may need to be divided into several pieces, and the pieces may be transmitted. Here, the Number of Fragments field 730 may indicate a number of fragments of the IPTV-SVC-INFO message 700 including all of the IPTV reception information.

The Fragment Number field 740 may identify the number for each IPTV-SVC-INFO message among a plurality of IPTV-SVC-INFO messages 700 including all IPTV reception information. For example, a value of the Fragment Number field 740 may be incremented by “1” starting from 1.

The Current Channel DCID field 750 may indicate an ID of a downstream channel where the IPTV-SVC-INFO message 700 is currently transmitted.

As shown in FIG. 8, the IPTV-SVC-INFO message 700 may include an IPTV Program Number field as a main field. The IPTV Program Number field may be used as an ID of an IPTV broadcast content.

An STB and a CM in a subscriber terminal may exchange information regarding an IPTV broadcast content selected by a viewer using the IPTV Program Number field. Additionally, the CM may set related reception information using the IPTV Program Number field.

The CM may filter IPTV packets from the IPTV broadcast content and transfer the IPTV packets to the STB using an assigned DSID. The IPTV-SVC-INFO message 700 may further include a Downstream Channel ID field and a MAC Domain Downstream Service Group (MD-DS-SG) ID field that indicates downstream channels where the IPTV broadcast content is currently transmitted.

The methods of providing IPTV reception information above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A subscriber terminal comprising:
a content receiver to receive a selected Internet Protocol Television (IPTV) broadcast content from a cable network using Layer 2 (L2) reception information, the L2 reception information being bounded to the IPTV broadcast content;
a decoder to decode the received IPTV broadcast content; and
a transmitter to transmit the decoded IPTV broadcast content to a display device.

2. The subscriber terminal of claim 1, further comprising:
a Cable Modem (CM) to provide an interactive service, the interactive service enabling the IPTV broadcast content and a Data Over Cable Service Interface Specification (DOCSIS) Media Access Control Management Message (MMM) to be received from the cable network, or enabling an IPTV broadcast content control signal to be transmitted from a subscriber to the cable network, the DOCSIS MMM comprising the L2 reception information based on service information.

3. The subscriber terminal of claim 2, wherein the content receiver receives information associated with the IPTV broadcast content from the cable network through the CM, based on content selection information of an IPTV broadcast content corresponding to the service information.

4. A content provider headend, comprising
a content receiver to receive an IPTV broadcast content from a content provider; and
a provider to provide a subscriber terminal with a DOCSIS MMM, the DOCSIS MMM comprising L2 reception information obtained by reflecting service information for the received IPTV broadcast content,
wherein the L2 reception information is used by the subscriber terminal to receive the IPTV broadcast content.

5. The content provider headend of claim 4, further comprising:
an IPTV server to form the service information associated with an IPTV broadcast content, the IPTV broadcast content being provided to the subscriber terminal.

6. The content provider headend of claim 4, wherein the service information comprises an Electronic Program Guide (EPG).

7. An apparatus of providing IPTV reception information, the apparatus comprising:
a content provider headend to receive an IPTV broadcast content from a content provider, and to provide the subscriber terminal with a DOCSIS MMM, the DOCSIS MMM comprising L2 reception information obtained by reflecting service information for the received IPTV broadcast content; and
a subscriber terminal to receive the IPTV broadcast content and the DOCSIS MMM from a cable network, to decode the received IPTV broadcast content, and to transmit the decoded IPTV broadcast content to a display device.

8. A method of operating a subscriber terminal, the method comprising:
receiving a selected IPTV broadcast content from a cable network using L2 reception information, the L2 reception information being bounded to the IPTV broadcast content;
decoding the received IPTV broadcast content; and
transmitting the decoded IPTV broadcast content to a display device.

9. A method of operating a content provider headend, the method comprising:
receiving an IPTV broadcast content from a content provider; and
providing a subscriber terminal with a DOCSIS MMM, the DOCSIS MMM comprising L2 reception information obtained by reflecting service information for the received IPTV broadcast content,
wherein the L2 reception information is used by the subscriber terminal to receive the IPTV broadcast content.

10. The method of claim 9, wherein the providing comprises:
selecting an IPTV broadcast content based on the service information; and
transmitting IPTV broadcast content information corresponding to the selected IPTV broadcast content to a CM,
wherein the IPTV broadcast content information is used by the CM to set related reception information.
